(19) United States
(12) Patent Application Publication
(10) Pub. No.: US 2004/0060914 A1
(43) Pub. Date: Apr. 1, 2004

(54) High efficiency welding electrodes

(76) Inventors: Bo-Young Lee, Kyunggi (KR); Young-Gak Gweon, Kyungsanbuk-do (KR)

Correspondence Address: Richard S Milner, Cooper & Dunham, 1185 Avenue of the Americas, New York, NY, 10036, US

(21) Appl. No.: 10/470,931

(22) PCT Filed: Feb. 9, 2002
(86) PCT No.: PCT/KR02/00225

(30) Foreign Application Priority Data
Feb. 13, 2001 (KR) 2001/7142

(51) Int. Cl. B23K 35/02

(52) U.S. Cl. 219/145.1

(57) ABSTRACT

The present invention relates to high efficiency welding electrodes, and more particularly, to an improvement in section structure of a wire rod for a fusion welding in which the section of the wire rod has a polygonal shape or is formed with a multiple of grooves in the longitudinal direction of the wire rod. Thereby, the sectional area of the wire rod becomes decreased and the surface area of the wire rod becomes increased. Therefore, a welding efficiency is highly improved.

### TECHNICAL FIELD

The present invention relates to a core wire of a welding electrode for fusion welding, and more particularly, to a core wire of a welding electrode for fusion welding with high welding efficiency, in which the cross sectional area is decreased and the surface area is increased, resulting from transforming the circular cross section of a core wire (see FIG. 1) into a polygonal cross section and/or forming the surface of a core wire with multiple notches in the longitudinal direction of the core wire.

### BACKGROUND ART

Generally, high welding current must be used in order to increase welding efficiency during welding. High welding current makes it possible to generate heat of electrical resistance in a welding electrode, resulting in the welding electrode being heated in its portion where current flows. If a welding electrode is heated, due to current consumed for heating of the welding electrode, welding arc energy is reduced and thus welding depth is lowered. In consideration of this problem, persons skilled in the art have made an every effort to reduce current loss caused by heat of electrical resistance by, for example, placing a contact terminal, which is used to feed welding current, at a position as close as possible to a welding arc to decrease the distance through which current flows.

However, if the contact terminal is placed too close to the arc, it is heated by arc heat and thus gets scorched and sticks to the welding electrode. Consequently, weld failure occurs. Therefore, attempts have been made to weld in a manner such that a contact terminal is placed at an appropriate position and welding current is set as high as possible. However, if welding current is too high, due to the generated heat of electrical resistance, a heated welding electrode is undesirably reduced in rigidity and is deviated from desired weld position.

Meanwhile, because current flows along the surface of a conductor, the larger the surface area of conductor, the more current flows. Based on this principle, if the surface of circular cross sectional core wire for a shielded metal arc, welding electrode is notched in various shapes, the notched core wire is increased in its surface area and is reduced in its cross sectional area, compared with a circular cross sectional core wire of the same-diameter.

In the case where welding is carried out using one welding electrode with an unnotched core wire and another welding electrode with a notched core wire of the same diameter, respectively, at the same current, the welding electrode with the notched core wire has higher current density than that with the unnotched core wire. This is because the former has a smaller cross sectional area than the latter. The higher the current density is, the greater the depth of penetration, the greater the amount of weld deposit, and the lower the arc blow.

Comparing one welding electrode with an unnotched core wire and another welding electrode with a notched core wire of the same diameter, the welding electrode with the notched core wire can use a higher current than the unnotched core wire during welding. This is because the former has a larger surface area.

A conventional shielded metal arc welding electrode has a core wire coated with a coating. Electrical resistance heat generated from welding current makes it possible to heat both the core wire and the coating. As a result, welding electrodes exceeding a certain length are of limited utility. Similarly, use of current exceeding a certain range must be limited, for the same reasons as above. Consequently, because a designated range of current must be used in a designated range of cross sectional area of a welding electrode, the amount of weld metal decreases. Specifically, welding efficiency decreases, welding depth is lowered, and arc blow is likely to occur.

In addition, the length of a shielded metal arc welding electrode varies with its diameter. Because weldability is improved with longer shielded metal arc welding electrodes, persons skilled in the art have tried to increase the length of the welding electrode. However, the longer the length of the welding electrode, the more the resistance heat is generated. Therefore, the length of the welding electrode is limited.

### DISCLOSURE OF THE INVENTION

Therefore, the present invention has been made in view of the above problems, and it is an object of the present invention to provide a core wire of a welding electrode for fusion welding with high welding efficiency, in which weld deposit efficiency is high, the depth of penetration is greater, and arc blow (magnetic blow) is reduced. The core wire may be, in addition to a core wire for fusion welding using an electrical resistance or an arc heat, any core wires for several different types of fusion welding processes such as protective gas welding using Ar, He, CO₂, N₂, O₂, H₂ as a protective gas, alone or in mixture, electro gas welding, submerged arc welding using flux, electro slag welding, and the like. Current generally flows along the surface of a conductor due to the “skin effect”, the tendency of current to flow near the surface of a conductor. Therefore, the larger the surface area of conductor, the more the current flows. Based on this principle, the surface of circular cross sectional core wire for fusion welding is notched so as to increase the surface area of the core wire (the circumference of cross section), thereby enabling use of higher current during welding.

In addition, in order to utilize the skin effect in the present invention, a circular cross section of a core wire for a shielded metal arc welding electrode is transformed to have a polygonal cross section such as a triangle, a pentagon and the like. Alternatively, the circular cross section is transformed into a polygon of 3 or more sides with rounded-off corners. Therefore, the surface area (the circumference of cross section) of the core wire for welding electrode is increased. As a result, a polygonal core wire can use higher current than a circular core wire of the same cross sectional area during welding.

Therefore, it is another object of the present invention to provide a core wire for a shielded metal arc welding electrode, in which welding efficiency is high, the depth of penetration is greater and arc blow is reduced, resulting from increasing current intensity and making the length of welding electrode longer, relative to a conventional shielded metal arc welding electrode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross sectional view of a circular cross sectional core wire according to the prior art;

FIG. 2 is a cross-sectional view of a octagonal cross sectional core wire of the present invention;

FIG. 3 is a cross sectional view of a rounded-off square cross sectional core wire of the present invention;

FIG. 4 is a cross sectional view of a 4 V-shape notched core wire of the present invention;

FIG. 5 is a cross sectional view of a 22 V-shape notched core wire of the present invention;

FIG. 6 is a cross sectional view of a shielded metal arc welding electrode containing a octagonal cross sectional core wire therein, according to the present invention;

FIG. 7 is a cross sectional view of a shielded metal arc welding electrode containing a rounded-off square cross sectional core wire therein, according to the present invention;

FIG. 8 is a cross sectional view of a shielded metal arc welding electrode containing a notched triangular cross sectional core wire therein, according to the present invention;

FIG. 9 is a cross sectional view of a shielded metal arc welding electrode containing a 12-notched core wire therein, according to the present invention; and

FIG. 10 is a cross sectional view of a shielded metal arc welding electrode containing an 8-notched core wire therein, according to the present invention.

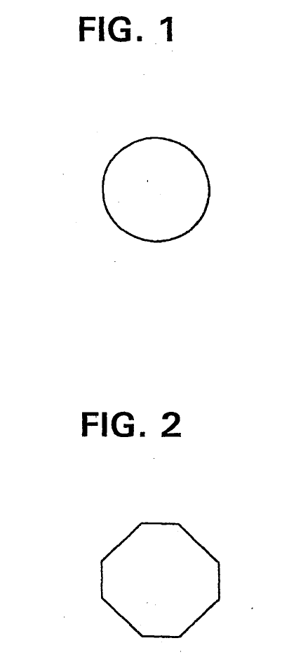

### BEST MODE FOR CARRYING OUT THE INVENTION

The above objects can be accomplished by the provision of a core wire, the surface of which is formed with multiple notches in the longitudinal direction of the core wire, or in helical forms angled from the longitudinal direction of the core wire. The notch formed in the surface of the core wire has a V-shaped, U-shaped, or 90° right-rotated U-shaped, or other similar configurations. The core wire is that intended for a shielded metal arc welding electrode.

Further, the core wire of the present invention may be processed to have a cross sectional shape of a polygon of 3 or more sides. Furthermore, the polygonal cross sectional core wire may be processed to have rounded-off corners. These types of core wires also are those intended for shielded metal arc welding electrodes.

Hereinafter, the present invention will be described in detail with reference to the accompanying figures.

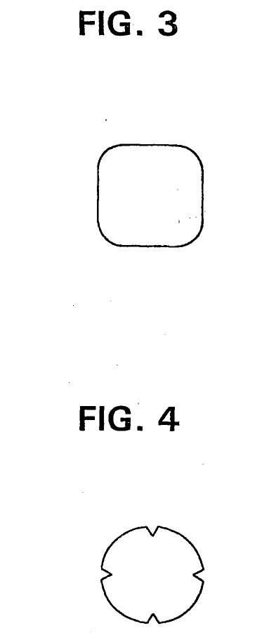

In one embodiment of the present invention, in order to increase the surface area of a conventional core wire, a circular cross section of the conventional core wire is transformed into a polygon of 3 or more sides such as triangle, square, pentagon and the like. Alternatively, corners are rounded off in the polygonal cross section. FIG. 2 is a octagonal cross sectional core wire of one aspect of the present invention. FIG. 3 is a rounded-off square cross sectional core wire of another aspect of the present invention.

Comparing a circle, a square and a octagon of the same area, where the radius of the circle is 10 mm, the circumferences of the circle, square and octagon are 62.8 mm, 70.9 mm and 65.9 mm, respectively. The circumference of the square is 12.9% longer than circle, and the circumference of the octagon is 4.9% longer than circle. If welding is carried out using such polygonal cross sectional core wire, higher welding current can be used, compared with a conventional circular cross sectional core wire.

The present inventors carried out welding at a current of 260A using a conventional circular cross sectional core wire 1.2 mm in diameter (hereinafter, referred to as Φ) and square and octagonal cross sectional core wires of the same cross sectional area as the circular core wire. The cross sectional area (mm²), the circumference of cross section (mm), the current density (A/mm²), the current intensity/circumference of the cross section (in Table 1, referred to simply as “current intensity”) (A/mm), the equivalent current intensity (A), which is defined as the current intensity required for applying the same current intensity/circumference of cross section as the circular cross section, and the current increase rate (%) of each of the above core wires, are shown in Table 1 below.

TABLE 1

| | | Square cross section | | Octagonal cross section | |
|---|---|---|---|---|---|
| | | Measured under the | Measured under the | Measured under the | Measured under the |
| | | same current density | same current intensity | same current density | same current intensity |
| | Circular | as the circular | as the circular | as the circular | as the circular |
| | cross section | cross section | cross section | cross section | cross section |
| Cross sectional area | 1.131 | 1.131 | 1.131 | 1.131 | 1.131 |
| (mm²) | | | | | |
| Circumference of | 3.77 | 4.25 | 4.25 | 3.96 | 3.96 |
| cross section (mm) | | | | | |
| Current density | 229.9 | 229.9 | 259.1 | 229.9 | 241.4 |
| (A/mm²) | | | | | |
| Current intensity | 69.0 | 61.1 | 69.0 | 65.7 | 69.0 |
| (A/mm) | | | | | |
| Equivalent current | 260 | | 293 | | 273.0 |
| intensity (A) | | | | | |
| Current increase rate | | | 12.7 | | 5 |
| (%) | | | | | |

Where the same welding current is used, the current intensity/circumference of the square cross sectional core wire is 61.1 A/mm, while that of the octagonal cross sectional core wire is 65.7 A/mm, which are all lower than that of a circular cross sectional core wire, 69 A/mm. In the case where the same current intensity/circumference as the circular cross sectional core wire is applied in each of both the square and octagonal cross sectional core wires, the equivalent current intensities of the square and octagonal cross sectional core wires are increased to 293A and 273A, respectively.

In order to greatly increase the surface area of the above polygonal core wire, the surface of the polygonal cross sectional core wire can be formed with multiple notches in a V-shape, U-shape or 90° right-rotated U-shape, or with rounded-off corners. More than one of notches can be formed in the longitudinal direction of the core wire, or in helical forms angled from the longitudinal direction of the core wire. The notches also may be arranged in a line intermittently.

The number of notches varies according to a welding object and the depth of notch. It ranges from one to the number able to be formed in the whole surface of core wire. The maximum number of notches may be four to twenty or more. A notched core wire has smaller cross sectional area than an unnotched core wire of the same diameter. Therefore, if the same current intensity is applied to each of both the core wires, current density is higher in the notched core wire, whereby the depth of penetration is greater, weld deposit efficiency increases, and arc blow is reduced. A notched core wire has a larger surface area than an unnotched core wire of the same cross sectional area. Therefore, the notched core wire can use higher welding current due to the skin effect. As a result, weld deposit efficiency increases, the depth of penetration is greater, and arc blow is reduced. Furthermore, the rigidity of the core wire increases and thus the feeding ability of the core wire is improved.

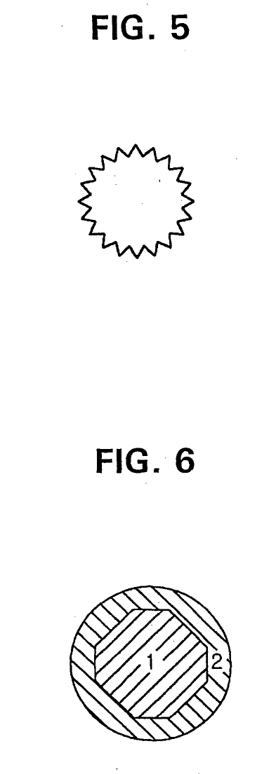

In another embodiment of the present invention, FIGS. 4 and 5 show cross sectional views of the inventive core wires, containing 4 and 22 V-shape notches, respectively. The depth of notch is defined such that the core wire can maintain its strength. Generally, it is defined to be 5% to 70% of the radius of the core wire. A notched core wire has smaller cross sectional area than an unnotched core wire of the same diameter. Therefore, if the same current intensity is applied to each of both the core wires, current density is higher in the notched core wire, whereby the depth of penetration is greater, weld deposit efficiency increases, and arc blow is reduced.

The present inventors carried out welding at a current of 260A using an unnotched core wire 1.2 mm in diameter (Φ) and 4, 12 and 16 V-shape notched core wires (angle of V-shape notch=60°, one side length of V-shape notch 0.2 mm). Table 2 below shows the cross sectional area (mm²), the circumference of cross section (mm), the current density (A/mm²), the current intensity/circumference of cross section (in Table 2, referred to simply as “current intensity”) (A/mm), the equivalent current intensity (A), which is defined as the current intensity required for applying the same current intensity/circumference as the unnotched core wire, and the current increase rate (%) of each of the above core wires.

TABLE 2

| | | 4 V-shape notches | | 12 V-shape notches | | 16 V-shape notches | |
|---|---|---|---|---|---|---|---|
| | | | Measured | | Measured | | Measured |
| | No notches | | under the | | under the | | under the |
| | (1.2 mmφ) | | same current | | same current | | same current |
| | Measured at | Measured at | intensity as | Measured at | intensity as | Measured at | intensity as |
| | 260 A | 260 A | the unnotched | 260 A | the unnotched | 260 A | the unnotched |
| Cross sectional | 1.131 | 1.029 | | 0.825 | | 0.723 | |
| area (mm²) | | | | | | | |
| Circumference | 3.770 | 4.666 | | 6.458 | | 7.36 | |
| of cross section | | | | | | | |
| (mm) | | | | | | | |
| Current density | 230 | 253 | | 315 | | 360 | |
| (A/mm) | | | | | | | |
| Current | 69 | 55.7 | 69 | 40.3 | 69 | 35.3 | 69 |
| intensity | | | | | | | |
| (A/mm) | | | | | | | |
| Equivalent | 260 | | 322 | | 446 | | 508 |
| current | | | | | | | |
| intensity (A) | | | | | | | |
| Current | — | 10.01 | 23.8 | 37.01 | 71.5 | 56.51 | 95.4 |
| increase rate | | | | | | | |
| (%) | | | | | | | |

As shown, in Table 2, in the case where current of 260A generally used in a conventional unnotched core wire is equally applied to the above three types of notched core wires, the current density of 4 V-shape notched core wire is 253 A/mm², which is 10% higher than the conventional unnotched core wire. The current densities of 12 and 16 V-shape notched core wires are 315 A/mm² and 360 A/mm², respectively, which are 37% and 56.5% higher than the conventional unnotched core wire.

The current intensity/circumference of a conventional unnotched core wire is 69 A/mm at the current of 260A. In order to equally apply the current intensity of 69A/mm to V-shape notched core wires, a 4 V-shape notched core wire must use the current intensity of 322A, which is 23.8% higher than that of the conventional unnotched core wire. In the same manner, 12 and 16 V-shape notched core wires must use the current intensities of 446A and 508A, respectively, which are 71.5% and 95.4% higher than that of the conventional unnotched core wire. Therefore, the welding current intensity can be increased by notching the surface of a core wire.

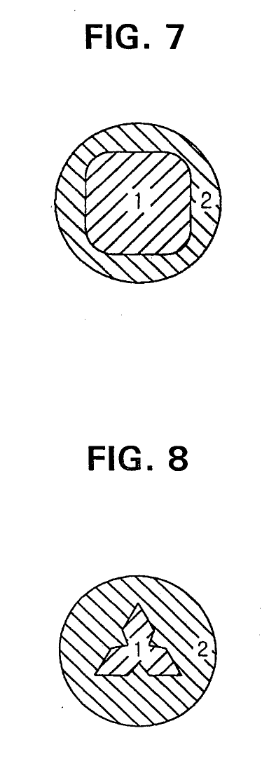

In still another embodiment of the present invention, there is provided a shielded arc welding electrode containing the above notched and/or polygonal cross sectional core wire therein. As mentioned above, in order to increase the surface area of a conventional core wire, a circular cross section of the conventional core wire is transformed into polygonal cross section such as a triangle, a square and a pentagon and the like. Alternatively, the circular cross section is processed to a polygon of 3 or more sides with its corners being rounded off. FIG. 6 is a cross sectional view of a shielded metal arc welding electrode containing a octagonal cross sectional core wire therein, according to one aspect of the present invention. FIG. 7 is a cross sectional view of a shielded metal arc welding electrode containing a rounded-off square cross sectional core wire therein, according to another aspect of the present invention. FIG. 8 is a cross sectional view of a shielded metal arc welding electrode containing a notched triangular cross sectional core wire therein, according to still another aspect of the present invention.

In order to greatly increase the surface area of the above polygonal core wire for a shielded metal arc welding electrode, the surface of the polygonal cross sectional core wire can be formed with multiple notches in a V-shape, U-shape or 90° right-rotated U-shape, or with rounded-off corners. The number of notches varies according to a welding object and the depth of notch. It ranges from one to the number able to be formed in the whole surface of core wire. The depth of notch is defined such that core wire can maintain its strength. Generally, it is defined to be less than 50% of the diameter of core wire.

A notched core wire has a smaller cross sectional area than an unnotched core wire of the same diameter. Therefore, if the same welding current intensity is applied to each of both the core wires, current density is higher in the notched core wire, whereby the depth of penetration is greater, weld deposit efficiency increases, and arc blow is reduced. A notched core wire has a larger surface area than an unnotched core wire of the same cross sectional area. Therefore, the notched core wire can use a higher welding current due to the skin effect. As a result, weld deposit efficiency increases, the depth of penetration is greater, and arc blow is reduced. Furthermore, the rigidity of the core wire increases and thus the feeding ability of the core wire is improved.

The present inventors carried out welding at a current of 160A using a conventional welding electrode containing a circular cross sectional core wire 4 mm in diameter (Φ) and the inventive welding electrodes each containing triangular, square and octagonal cross sectional core wires of the same cross sectional area as the circular core wire. Table 3 below shows the cross sectional area (mm²), the circumference of cross section (mm), the current density (A/mm²), the current intensity/circumference of cross section (in Table 3, referred to simply as “current intensity”) (A/mm), the equivalent current intensity (A), which is defined as the current intensity required for applying the same current intensity/circumference as the circular cross sectional core wire, and the current increase rate (%) of each of the above core wires.

TABLE 3

| | | Triangular core wire | | Square core wire | | Octagonal core wire | |
|---|---|---|---|---|---|---|---|
| | | Measured under | Measured under | Measured under | Measured under | Measured under | Measured under |
| | Circular | the same current | the same current | the same current | the same current | the same current | the same current |
| | core wire | density as the | intensity as the | density as the | intensity as the | density as the | intensity as the |
| | (4 mmφ) | circular core wire | circular core wire | circular core wire | circular core wire | circular core wire | circular core wire |
| Cross sectional | 12.6 | 12.6 | 12.6 | 12.6 | 12.6 | 12.6 | 12.6 |
| area (mm²) | | | | | | | |
| Circumference of | 12.6 | 16.2 | 16.2 | 14.2 | 14.2 | 13.2 | 13.2 |
| cross section (mm) | | | | | | | |
| Current density | 12.7 | 12.7 | | 12.7 | | 12.7 | |
| (A/mm²) | | | | | | | |
| Current intensity | 12.7 | 9.9 | 12.7 | 11.3 | 12.7 | 12.1 | 12.7 |
| (A/mm) | | | | | | | |
| Equivalent current | 160 | 160 | 205.7 | 160 | 180.3 | 160 | 167.6 |
| intensity (A) | | | | | | | |
| Current increase rate | | | 28.6 | | 12.7 | | 4.8 |
| (%) | | | | | | | |

Where the same welding current is used, the current intensity/circumference of the triangular cross sectional core wire is 9.9 A/mm, that of the square cross sectional core wire is 11.3 A/mm, and that of the octagonal cross sectional core wire is 12.1 A/mm, which are all lower than that of a circular cross sectional core wire of 12.7 A/mm. In the case where the same current intensity/circumference as the circular cross sectional core wire is applied in each of the triangular, square and octagonal cross sectional core wires, the equivalent current intensities of the triangular, square and octagonal cross sectional core wires are increased to be 205.7 A, 180.3 A and 167.6A, respectively. If the surface of the polygonal cross sectional core wire is notched, the circumference of the cross section of the core wire is greatly increased by controlling the shape, depth and number of notches. Therefore, higher welding current can be used during welding.

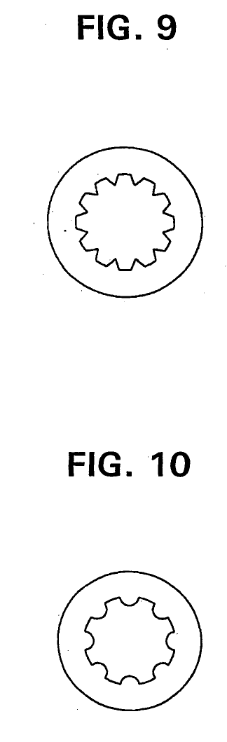

FIG. 9 is a cross sectional view of a shielded metal arc welding electrode containing a 12-notched core wire therein, according to the present invention, and FIG. 10 is a cross sectional view of a shielded metal arc welding electrode containing an 8-notched core wire therein, according to the present invention.

The present inventors carried out welding at a current of 160A using a conventional welding electrode containing an unnotched core wire 4 mm in diameter (Φ) and the inventive welding electrodes containing 8, 12 and 18 V-shape notched core wires (angle of V-shape notch=60°, one side length of V-shape notch=0.5 mm). Table 4 below shows the cross sectional area (mm²), the circumference of cross section (mm), the current density (A/mm²), the current intensity/circumference of cross section (in Table. 4, referred to simply as “current intensity”) (A/mm), the equivalent current intensity (A), which is defined as the current intensity required for applying the same current intensity/circumference as the unnotched core wire, and the current increase rate (%) of each of the above core wires.

TABLE 4

| | No notches | 8 V-shape | 12 V-shape | 18 V-shape |
|---|---|---|---|---|
| | (4 mmφ) | notches | notches | notches |
| Cross sectional | 12.566 | 9.717 | 8.293 | 6.156 |
| area (mm/²) | | | | |
| Circumference | 12.566 | 14.98 | 16.19 | 18.0 |
| of cross | | | | |
| section (mm) | | | | |
| Current density | 12.733 | 16.47 | 19.29 | 25.99 |
| (A/mm) | | | | |
| Current intensity | 12.733 | 10.68 | 9.88 | 8.89 |
| (A/mm) | | | | |
| Equivalent | 160 | 191 | 206 | 229 |
| current | | | | |
| intensity (A) | | | | |
| Current increase | | 19.2 | 28.8 | 43.3 |
| rate (%) | | | | |

1) Current Density

As shown in Table 4, where a current of 160A, generally used in a conventional welding electrode containing an unnotched core wire 4 mm in diameter, is equally applied to the above three types of the inventive welding electrodes containing notched core wires, the current density of the 8 V-shape notched core wire is 16.47 A/mm², which is 29.3% higher than the conventional unnotched core wire. The current densities of 12 and 18 V-shape notched core wires are 19.29 A/mm² and 25.99 A/mm², respectively, which each are 51.5% and 104.1% higher than the conventional unnotched core wire.

2) Current Intensity/Circumference

In the case where a current of 160A, generally used in a conventional welding electrode containing an unnotched core wire 4 mm in diameter is equally applied to the above three types of the inventive welding electrodes containing notched core wires, the current intensity/circumference of a conventional, unnotched core wire is 12.733 A/mm. In order to apply the current intensity/circumference of 12.733A/mm to V-shape notched core wires, an 8 V-shape notched core wire must use the current intensity of 191A, which is 19.2% higher than that of the conventional unnotched core wire of 160A. In the same manner, 12 and 18 V-shape notched core wires must use the current intensities of 206A and 229A, respectively, which each are 28.8% and 43.3% higher than that of the conventional unnotched core wire.

The material of the core wire used in the present invention is that used in fusion welding using the electrical resistance or arc heat of the core wire, such as carbon steel with a yield strength of 10 MPa to 3,000 MPa, low alloy steel, high alloy steel including stainless steel, cast iron, aluminum and aluminum alloy, nickel and nickel alloy, copper and copper alloy, titanium and titanium alloy.

Industrial Applicability

As apparent from the above description, comparing the conventional circular cross sectional core wire and the inventive polygonal cross sectional core wire of the same cross sectional area, the surface area of the polygonal core wire is larger than that of the conventional core wire. Further, if the surface of the polygonal cross sectional core wire is notched, the surface area of the notched core wire is much larger than that of an unnotched core wire. Therefore, the current intensities of the notched and/or polygonal cross sectional core wires are greatly increased relative to a circular cross sectional core wire. Consequently, the inventive core wire is excellent in that the amount of weld deposit increases, the depth of penetration is greater, arc blow is reduced, and the feeding ability of the core wire is improved.

Accordingly, in the case where a shielded metal arc welding electrode containing the inventive core wire therein is used during welding, welding efficiency is improved, the depth of penetration is greater and arc blow is reduced. Furthermore, a welding electrode with a longer length can be utilized.

Although the: preferred embodiments of the present invention have been disclosed for illustrative purposes, those skilled in the art will appreciate that various modifications, additions and substitutions are possible, without departing from the scope and spirit of the invention as disclosed in the accompanying claims.

1. A core wire with high welding efficiency, the surface of which is formed with multiple notches in the longitudinal direction of the core wire, or in helical forms angled from the longitudinal direction of the core wire.

2. The core wire as set forth in claim 1, wherein the notch formed in the surface of the core wire has a V-shaped, U-shaped and 90° right-rotated U-shaped configuration, alone or in combination.

3. The core wire as set forth in claim 1 or claim 2, wherein the core wire is that intended for a shielded metal arc welding electrode.

4. A core wire having a cross sectional shape of a polygon of 3 or more sides.

5. The core wire as set forth in claim 4, wherein the polygonal cross section of the core wire is processed to have rounded-off corners.

6. The core wire as set forth in claim 4 or claim 5, wherein the core wire is that intended for a shielded metal arc welding electrode.

7. The core wire as set forth in claim 4 or claim 5, wherein the notch formed in the surface of the core-wire has a V-shaped, U-shaped and 90° right-rotated U-shaped configuration, alone or in combination.
